(19) United States
(12) Patent Application Publication
(10) Pub. No.: US 2003/0165211 A1
(43) Pub. Date: Sep. 4, 2003

(54) Detectors for x-rays and neutrons

(76) Inventors: Lee Grodzins, Lexington, MA (US); Peter Rothschild, Boston, MA (US)

Correspondence Address: BROMBERG & SUNSTEIN LLP, 125 SUMMER STREET, BOSTON, MA, 02110-1618, US

(21) Appl. No.: 10/156,989

(22) Filed: May 29, 2002

Related U.S. Application Data
(60) Provisional application No. 60/360,854, filed on Mar. 1, 2002.

(51) Int. Cl. G01T 1/00

(52) U.S. Cl. 376/155

(57) ABSTRACT

An apparatus and method for detecting neutrons, particularly, with directional sensitivity. The apparatus is a detector with a scintillator containing high neutron-capture-cross-section atoms for capturing neutrons and emitting electromagnetic radiation, and an optical detector for detecting the emitted electromagnetic radiation and for generating an electrical signal. The high neutron-capture-cross-section atoms may be gadolynium, in particular, and the detector may additionally have a moderator for converting fast neutrons into thermal neutrons that are then captured by the high neutron-capture-cross-section atoms.

The present application claims priority from U.S. Provisional Application No. 60/360,854, filed Mar. 1, 2002, which is herein incorporated by reference.

### TECHNICAL FIELD

The present invention relates to devices and methods for detecting neutrons and high-energy photons such as x-rays and gamma rays.

### BACKGROUND OF THE INVENTION

An effective means for detecting radioactive sources, “dirty bombs,” and fissile, and thus neutron- and gamma-ray-emitting, material in baggage at airports or in freight cargo is obviously desirable. Passive detection in conjunction with other inspection protocols would be advantageous.

### SUMMARY OF THE INVENTION

In accordance with preferred embodiments of the present invention, there is provided a detector for detecting neutrons. The detector has a scintillator containing high neutron-capture-cross-section atoms for capturing neutrons and emitting electrons and electromagnetic radiation, and an optical detector for detecting the emitted electromagnetic radiation and for generating an electrical signal. The high neutron-capture-cross-section atoms may be chosen from the group including gadolinium, boron, and cadmium, and the scintillator, in particular, may be Gd₂S₂O. The detector may additionally have a moderator for converting fast neutrons into thermal neutrons to be captured by the high neutron-capture-cross-section atoms. The optical detector may include a photodiode or a photomultiplier tube.

In accordance with other embodiments of the present invention, a method is provided for detecting neutrons. In accordance with the method, a scintillator is provided that contains high neutron-capture-cross-section atoms for capturing the neutrons and emitting electromagnetic radiation, with at least one dimension of the scintillator exceeding the mean free path of an optical scintillation photon of a specified wavelength range in the scintillator. Photons at the specified wavelength range are detected with a photodetector characterized by a position with respect to the scintillator. In accordance with an alternate embodiment of the invention, a direction of a detected neutron may be inferred based on the position of the photodetector detecting scintillation photons.

In accordance with yet other embodiments of the invention, a detector is provided for detecting high-energy photons with enhanced efficiency. The detector has a first scintillator screen, a second scintillator screen in a path of photons that have traversed the first scintillator screen, and a heavy element backing in a path of photons that have traversed the second scintillator screen for generating Auger electrons and concomitant secondary photons. Finally, the detector has a photodetector for detecting visible photons arising in the first and second scintillators.

A method is also provided, in accordance with embodiments of the invention, for detecting concealed fissile material. In accordance with the method, there is provided:

i. a first scintillator screen for absorbing massive fission products and generating visible light;

ii. a heavy element backing in a path of photons that have traversed the first scintillator screen for generating Auger electrons and concomitant secondary photons.

Visible photons arising in the scintillator are detected. An additional scintillator screen may be provided in the path of photons, both for increasing the efficiency of x-ray detection and for detecting neutrons. In the latter case, the additional scintillator screen is a scintillator, such as gadox, containing a high-neutron-capture cross-section element.

### BRIEF DESCRIPTION OF THE DRAWINGS

The foregoing features of the invention will be more readily understood by reference to the following detailed description taken with the accompanying drawings:

FIG. 1 is a schematic view of essential elements of a thermal neutron detector in accordance with preferred embodiments of the present invention;

FIG. 2 is a schematic view of a 4π thermal neutron detector in accordance with embodiments of the present invention;

FIG. 3 is a schematic view showing the use of backscatter detectors of a cargo inspection system for detection of thermal neutrons in accordance with preferred embodiments of the present invention;

FIG. 4 is schematic view of essential elements of an enhanced x-ray or gamma ray detector in accordance with preferred embodiments of the present invention; and

FIG. 5 is a schematic view of a combined enhanced photon detector and thermal neutron detector in accordance with further embodiments of the present invention.

### DETAILED DESCRIPTION OF PREFERRED EMBODIMENTS

In accordance with one embodiment of the present invention, a high-efficiency detector for thermal neutrons is described. An application of the invention to enhancing the efficiency of scintillation screens for detecting electromagnetic radiation in the range above about 90 keV, and the combination of the foregoing embodiments for highly efficient detection of fissionable material such as uranium and plutonium are discussed below.

Thermal Neutron Detector

A new type of detector is described herein that has high efficiency for detecting thermal and epi-thermal (intermediate energy, typically 1-10⁴ eV) neutrons. The detector uses the scintillator Gd₂O₂S, commonly known, and referred to herein, as “gadox,” to stop both neutrons and the photons. Gadox is well-known as a scintillating material for x-rays and is used in x-ray detection applications, such as in sheets for lining the inner surfaces of x-ray detector boxes in x-ray inspection products. X-ray-induced scintillations from the gadox in the visible portion of the spectrum are then detected, typically by photomultipliers or photodiodes. Gadox has good efficiency for stopping photons of energies below about 100 keV and converting the ionization energy into optical light that can be detected by a photomultiplier tube (PMT) or photodiode.

Gadox may be doped with various elements, typically rare earths, with the dopants determining the optical spectrum and the lifetime of the optical transitions. Gd₂O₂S:Pr is a preferred dopant in that the lifetime of the light output is short, <5 μs (depending upon the amount of Pr), and the light is emitted primarily at a single wavelength, 511 nanometers, so there is very little “afterglow” that occurs from multiple wave length emission some of which are long lived. It is to be understood that for purposes of neutron detection, the use of any dopant falls within the scope of the present invention.

The nucleus of the gadolinium isotope ¹⁵⁷Gd is also a highly efficient absorber of thermal neutrons, with a thermal neutron cross section of 255,000 barns. Natural gadolinium, in which the ¹⁵⁷Gd isotope comprises a 15.7% component, has a 49,000 barn cross section for thermal neutrons, the highest by far of any element. The mean free path of the ¹⁵⁷Gd isotope for capturing thermal neutrons is only 1 mg/cm², whereas the mean free path of scintillator gadox, made from naturally occurring gadolinium, is 8.2 mg/cm2.

The absorption of a neutron by ¹⁵⁷Gd leads to ¹⁵⁸Gd, with an excess energy of 7.9 MeV. This energy is dissipated in a cascade of gamma rays as the nucleus passes from upper to lower quantum states. The 79.5-keV first excited state of ¹⁵⁸Gd takes part in most of the cascades. In particular, the 79.5 keV state, with a half-life of 2.52 nsecs, decays by either of two modes, either direct emission of a gamma ray photon, or ejection of an electron. A 79.5 keV gamma ray is emitted in about 15% of the decays. The majority of the 79.5 keV states decay, however, by internal conversion, a process by which the energy is transferred to atomic electrons. About 30% of the decays of the 79.5 keV state eject a K electron with a kinetic energy of 29.3 keV. Most of the remaining 79.5 keV states eject L electrons with energies between 69 keV to 72 keV. In sum, the capture of a thermal neutron in gadox results in the emission of a spectrum of monochromatic electrons which stop in the gadox producing approximate 20 optical photons for every kilovolt of energy lost. We estimate that at least one in 2 neutrons that pass through a 20 mg/cm² gadox scintillator will produce a burst of hundreds of optical photons for detection by a photomultiplier tube; that is, a thin gadox scintillator can have a 50% efficiency for detecting thermal neutrons. By this we mean that at least half the incident neutrons will be detected.

While the description provided herein refers to the invention in terms of Gd₂O₂S, it is to be understood that the invention may also be practiced using another x-ray or gamma-ray scintillator material, one of whose constituents is boron, cadmium, gadolinium, or other strongly neutron absorbing element.

For purposes of clarity, the present invention is distinguished from the incidental use of gadolinium (or boron) in plastic scintillators where the element is not used for scintillation but merely to produce radiations that are subsequently detected in plastic scintillators. Gd in the plastic is an inert element; it takes no part in the scintillation process and is not required for scintillation; indeed it deteriorates the scintillators effectiveness by shortening the mean free path of the optical emission, which is why, typically, only 1% by weight can be used. The present invention, in that gadox contains 79.5% Gd, has an efficiency exceeding that of plastic scintillators by about two orders of magnitude. The present invention may also advantageously provide smaller, lighter, and lower-cost detectors, and versatility for special geometries.

Cerium-doped Gd₂SiO₅ (“GSO”) may also be used in the context of the invention described herein, in crystalline or polycrystalline forms.

Additionally, phosphors containing elements of high neutron-capture cross-section may be employed, in accordance with other embodiments of the present invention, to yield a screen providing a direct image of thermal neutrons that may be optically imaged by a camera such as a pinhole or multiple pin-hole camera. Such phosphors include, for example, YₓGd_{1-xxBO}₃:Eu.

With respect to gadox, it is to be noted that gadox screens are typically made of polycrystalline Gd₂O₂S, which has a short mean free path for the optical light generated when ionizing radiation passes through. Gadox self-absorbs its own emitted light with a mean free path of from 75 to 150 mg/cm² depending on the amount of dopant in the scintillator. Thicknesses much greater than the mean free path of the optical light are of no use since much of the light is absorbed before reaching the PMTs.

If the gadox is viewed by a PMT that efficiently detects the emitted optical light, and the signals are analyzed in an energy-dispersive mode, then x-rays and neutrons can be effectively sorted since the neutrons result in a spectrum of lines around 30 keV and 70 keV, while the signals from x-rays and gamma rays typically produce quite different pulse heights. The 79.5 keV gamma ray emitted in the decay of ¹⁵⁸Gd, when captured by the gadox, produces the same signals as does the internal conversion electrons, and thereby increases the efficiency of detecting thermal neutrons. Even without energy discrimination, the x-rays and neutrons can be sorted by virtue of details of the detection mechanism, as described below.

A thickness of 20 mg/cm² of gadox is sufficient to stop the neutrons (>2 mean free paths) as well as the electrons produced in the (n,γ) reaction. A 20 mg/cm² gadox thickness produces a readily detectable signal of from 500 to 1,000 or so optical photons from the stopped electrons. The short stopping thickness of gadox for thermal neutrons is in sharp contrast to the long mean free paths for x-rays: the mean free paths of x-rays of 40 keV, 100 keV, and 185 keV are 200 mg/cm², 400 mg/cm², and 1800 mg/cm², respectively. (In practice, the thickest gadox screens that one can use is about 150 mg/cm², as discussed above.)

Thus while substantially opaque to thermal neutrons, a 20 mg/cm² gadox screen has a detection efficiency of only about 5% for detecting a 100 keV x-ray, indeed, it is almost transparent to photons in the range of 100 kev and above. The different mean free paths can be used to make a “4π” neutron only detector, or a directional neutron detector, or a “4π” neutron plus x-ray detector, or a directional detector for both x-rays and neutrons, as discussed in greater detail below.

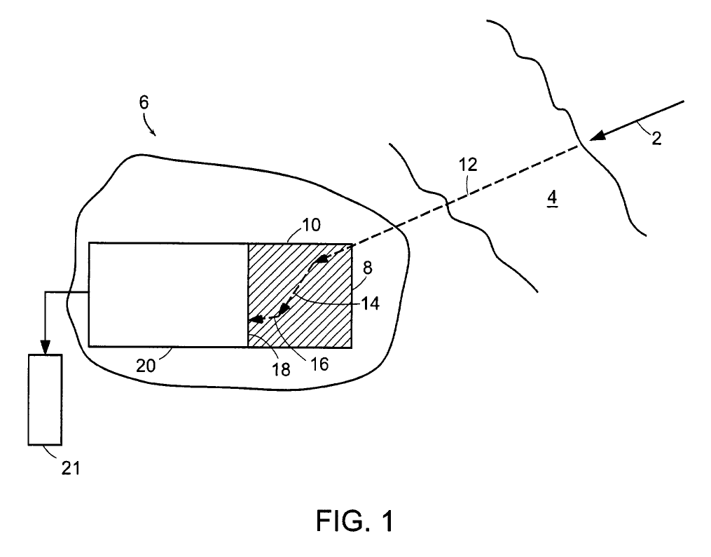

FIG. 1 shows the essential elements of a neutron detector 6. A gadox scintillator screen 10, covered by an optical shield 8 that reflects the internally generated light, is viewed by a PMT 20. Thermal neutrons entering the gadox 10 along path 12 are absorbed by the ¹⁵⁷Gd and Auger (internal conversion) electrons 14 are produced. The electrons 14, with energies in the 24 to 70 kev range, stop in the gadox 10 producing optical photons 16. The optical photons 16 are captured by the photocathode 18 of the PMT 20, producing a signal at the anode that is processed by pulse electronics 21. The neutrons 12 are stopped in the first 20 mg/cm² of the gadox 10. The optical photons 16 have a maximum travel of about 200 mg/cm² in gadox. A region 4 of a moderator material, such as paraffin, for example, may be provided in order to slow any fast neturons 2 and enable their detection in the manner herein described with respect to thermal neutrons.

If the gadox is thicker than the maximum optical photon travel distance, then neutrons stopping in the outer layer are not detected. Neutrons entering the gadox from the side facing the PMT photocathode are readily detected.

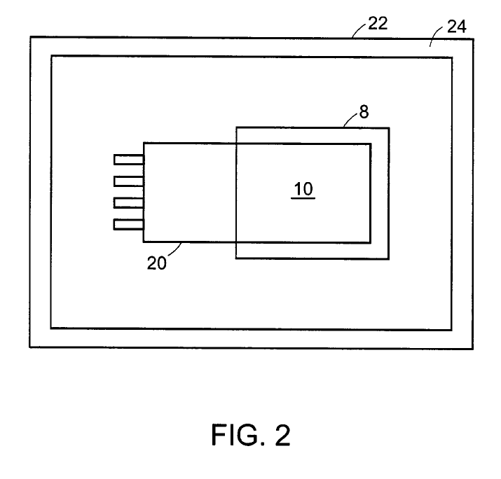

Referring now to FIG. 2, a “4π” neutron-only detector is made by placing a 20 mg/cm² thick gadox screen 10, with its accompanying optical shield and reflector 8 and photodetector(s) 20, in a box 22 shielded by a material 24 opaque to x-rays. Shield 24 may be 5 mm thickness of bismuth or 1 cm of lead, to cite two examples. Bismuth, with a mean free path of 17 cm for thermal neutrons, is essentially transparent to the neutrons but effectively shields the gadox from x-rays and gamma rays that have any appreciable interaction with the gadox.

To make a directional detector of neutrons, the gadox need only be much thicker than the mean free path of the optical light, say 300 mg/cm². The light detected by a PMT must have come from neutrons that entered from the side of the gadox facing the photocathode of the PMT. This embodiment, when unshielded with respect to x-rays, is also a directional detector for x-rays that have a mean free path much less than 150 mg/cm² in gadox. And when this detector is placed in a bismuth-lined box, it may be rendered sensitive to neutrons only.

Alternative versions of the invention for detection of neutrons and x-rays make use of back-to-back gadox screens separated by an opaque film, or combinations of gadox and scintillation screens that do not contain gadolinium and are essentially transparent to neutrons.

In accordance with further versions of the invention, a moderator, such as paraffin, is employed to convert fast neutrons into thermal neutrons. Thus, fast neutrons, such as those emitted by Plutonium, may advantageously be detected in the manner described above with respect to thermal neutrons.

In accordance with yet a further embodiment of the invention, a hand-held thermal neutron detector employs one of a variety of different configurations. One example is a hand-held, thermal neutron detector that signals the general direction of the origin of the neutron. A gadox screen, typically on the order of 300 mg/cm² thick, is sandwiched between two, rectangular, side-window PMTs that efficiently detect the fluorescent light emitted by the gadox. Each photomultiplier only detects neutrons that enter the gadox from the face facing the PMT. The signals from each PMT are processed and analyzed by techniques well known in the art; commercial signal processors of PMT signals are available that consume little space and power and easily fit in a hand-held instrument. The pulse heights from each PMT are sorted into those produced by neutrons and x-rays. The detector thus described, without a collimator gives only a two-value directionality of the neutrons. More precise directionality can be attained with the use of collimators made from material such as gadolinium, boron or cadmium that strongly absorb the neutrons.

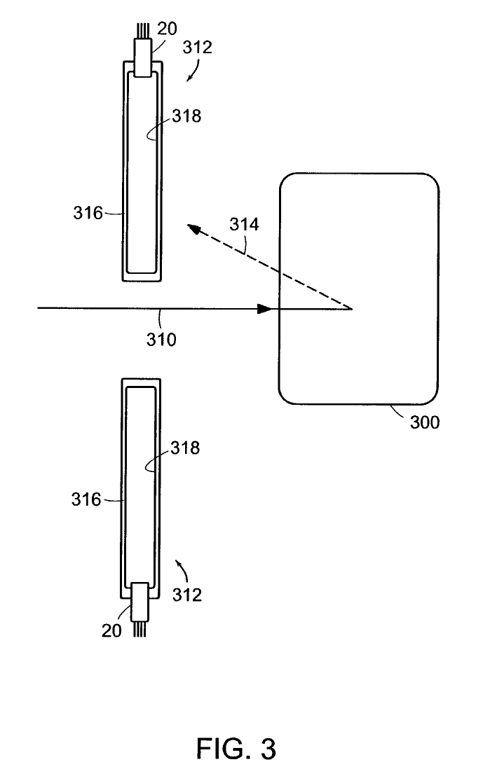

One preferred embodiment of the gadox detectors is in x-ray inspection systems to find neutron-emitting material in baggage at airports or in freight cargo. Referring now to FIG. 3, baggage or cargo 300 is irradiated by x-ray beam 310, typically swept as a pencil beam in a scanning pattern across object 300. Other beam shapes, however, are within the scope of the present invention. Detectors 312 of backscattered x-rays 314 are hollow rectangular boxes whose inner surfaces are lined with gadox 316, approximately 150 mg/cm² thick, or, alternatively, gadox and another scintillator that does not absorb neutrons. Photomultipliers 20 intrude into the boxes to detect the fluorescent light. In order to transform the backscatter detectors into efficient neutron detectors as well as x-ray detectors, the gadox 318 on the surfaces facing the inspected container 300 are thin enough that fluorescent light from the neutrons stopped in the outer 10 mg/cm² layer can efficiently escape out of the scintillator and be detected by the PMTs. A more effective solution is to add a separate section to the backscatter detectors with additional PMTs.

Alternatively, thick gadox can be placed on the surface furthest away from the inspected container, and a scintillator that is essentially transparent to neutrons can be place on the suface facing the inspected container. In this embodiment, the neutrons will be absorbed on the inner surface of the gadox, allowing the scintillation light to be detected by the PMTs. Gamma rays and x-rays will be absorbed and detected in both the gadox and the other scintillator. In this way, the efficiency for absorbing and detecting high energy x-rays or gamma rays may be maximized.

Gadox scintillation screens can be placed, in accordance with other embodiments of the invention, on traditional gamma ray detectors that have excellent efficiency for detection of both high and low energy x-rays or gamma rays. In this embodiment, the gamma ray detectors act as light conduits for the fluorescent light produced by the gadox screens. For example, the gadox can be optically coupled to plastic scintillators viewed by PMTs, the latter is used by AS&E to efficiently detect high energy gamma rays. Alternatively, the gadox can be optically coupled to high-Z gamma ray detectors such as NaI(Tl), BGO, CsI(Tl), etc. The signals from the two distinct scintillators, one of which is gadox, can generally viewed by a single PMT with the signals from the two scintillators distinguished by their different pulse shapes, a technique well known in the art. When two distinct scintillators, one of which is gadox, are viewed by two PMT's, the signals from the two scintillators can be separated by placing a notch filter for the 511 nanometer line on one of the PMTs so that it only counts light from the gadox.

Gamma Ray Detection Enhancement

In accordance with further embodiments of the invention, the detection efficiency of scintillation screen detectors is enhanced for x-rays above about 70 keV, with particular utility for x-ray energies in the 100 keV to 200 keV range.

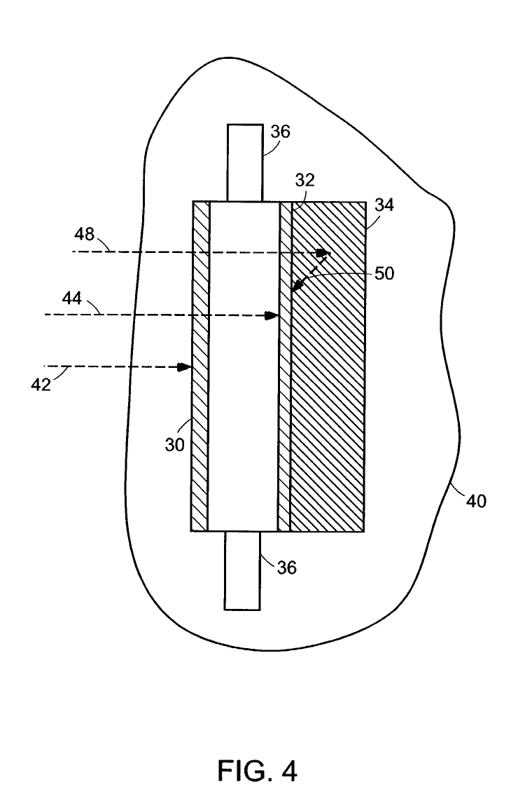

Advantage is taken of the fact that heavy materials such as tungsten, lead and uranium are excellent converters of higher energy photons to lower energy photons, which, in turn, are more efficiently detected by the gadox. The invention is now described with reference to the schematic shown in FIG. 4.

X-rays 42,44, 48 or gamma rays 42, 44, 48 impinge on the detector 40, which consists of a scintillator 30, such as gadox, lining the inside of the front face, a scintillator 32, such as gadox, lining the inside of the back face of the detector, PMTs 36 viewing the interior of the detector to measure the intensity of the light emitted from the gadox, and a sheet 34 of a heavy element, such as lead, backing the scintillator 32.

The operation of the detector is illustrated by imagining that 100, 100 keV x-rays (such as the K x-ray of uranium) and 100, 185 keV gamma rays (from the decay of fissionable ²³⁵U) impinge on the detector. The screens 30, 32 are assumed to be 150 mg/cm² gadox, their maximum effective thickness. The backing 34 is assumed to be 5 mm of lead, which is thick enough to stop the 100 kev and 185 keV photons. We consider each radiation in turn; the numbers in the examples are approximations provided solely for purposes of illustrating the principles described herein.

The front gadox layer 30 stops and detects about 30 of the 100 keV x-rays, letting 70 x-rays through. The back gadox layer 32 stops 21 of the 70 x-rays so that if the lead sheet 34 were not present, 49 x-rays would pass out the back end of the detector; the efficiency of the detector for 100 keV x-rays would be ˜50%.

In the configuration of FIG. 4, the remaining 100 keV x-rays 48 stop in the lead sheet, 34. The stopping is primarily the result of the 100 keV x-rays ejecting K electrons 50 from the lead atoms (the photoelectric effect). When the excited lead atoms deexcite, which they do in less than a picosecond, K x-rays are emitted with energies of 72 and 75 keV; for illustration we use the dominant 75 keV x-ray. The fraction of incident x-rays that result in K x-rays emitted backwards into the detector is given by the ratio,

F˜μ(photoelectric)/[μ(total for 100 keV)+μ(total for 75 keV)]=0.68.

The actual fraction will be lower because of the finite angular spreads and the finite fluorescent yield, but will still be close to 50%. Thus, about 25 of the 49 x-rays that entered the lead backing will result in 72-75 keV x-rays reentering the chamber. The 300 mg/cm² of gadox captures 80% of these x-rays so that ˜20 of the 49 x-rays are detected. The lead backing has increased the efficiency of the detector for 100 kev x-rays from 50% to 70% at a cost of a sheet of lead.

The calculation for the 185 keV gamma ray impinging on the detector proceeds similarly. Of the 100 incident gammas, only 9% interact at all in the gadox, so that more than 90 gamma rays penetrate into the lead. Approximately 30% of these gamma rays produce lead K x-rays that reenter the backscatter detector. The result is that approximately 20 additional gamma rays are detected over what would have been detected without the lead. The efficiency of the detector has increased from 9% to 29% by the addition of a sheet of lead.

Combined Neutron Detector and Enhanced Gamma Ray Detector

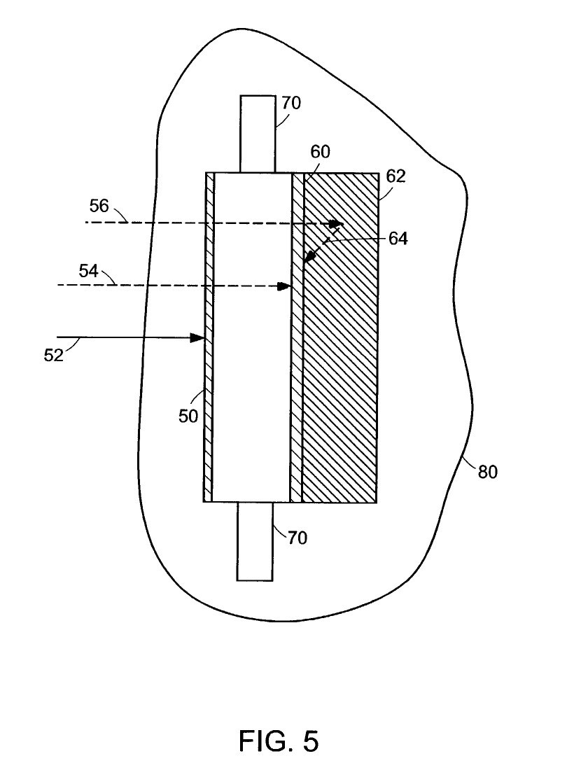

The invention described herein is advantageously applied to the efficient detection of fissionable material that may be transported illegally by smugglers or terrorists. FIG. 5 shows a simple detector 80 that has excellent efficiency for thermal neutron capture, and good efficiency for both the K x-rays of uranium or plutonium and the 185 keV gamma rays emitted by fissionable uranium. Detection of fast neutrons by employing an intervening moderator is discussed elsewhere herein.

The configuration is similar to that of FIG. 4, the only substantive difference is that the first gadox layer 50 is only 20 mg/cm² thick. That front layer stops the thermal neutrons 52 producing strong signals in the PMTs corresponding to the deposition of 25 keV and 70 keV electrons. A fraction of the 100 keV and 185 keV photons stop in a back scintillator layer 60, the remainder stop in the lead backing 64. The back scintillator layer 60, in accordance with one embodiment, may itself be gadox or another high-neutron-capture material, and, more specifically, may have a thickness of 150 mg/cm².

The overall detection efficiency for the 100 keV and 185 keV radiations is about 60% and 25% respectively. The detection efficiency for thermal neutrons is ˜50%.

Other configurations of successive scintillator panels are also within the scope of the present invention. If the first detector is thin gadox then the second detector can be any scintillator with good stopping power, including gadox. Alternatively, the first detector may be a scintillator other than gadox while the second detector is gadox.

If the second detector is gadox, then, within the scope of the present invention, the first detector can be thin gadox or a scintillator other than gadox.

While the invention has been described in detail, it is to be clearly understood that the same is by way of illustration and example and is not to be taken by way of limitation. Indeed, numerous variations and modifications will be apparent to those skilled in the art.

We claim:

1. A detector for detecting neutrons, the detector comprising:
a. a scintillator containing high neutron-capture-cross-section atoms for capturing the neutrons and emitting electromagnetic radiation; and
b. an optical detector for detecting the emitted electromagnetic radiation and generating an electrical signal.

2. A detector in accordance with claim 1, wherein the high neutron-capture-cross-section atoms are chosen from a group including gadolinium, boron, and cadmium.

3. A detector in accordance with claim 1, further comprising a moderator material for converting fast neutrons into thermal neutrons to be captured by the high neutron-capture corss-section atoms.

4. A detector in accordance with claim 1, wherein the scintillator is Gd₂S₂O.

5. A detector in accordance with claim 1, wherein the scintillator is doped Gd₂S₂O.

6. A detector in accordance with claim 1, wherein the optical detector includes at least one photodiode.

7. A detector in accordance with claim 1, wherein the optical detector includes at least one photomultiplier tube.

8. A method for detecting neutrons, the method comprising:
a. providing a scintillator containing high neutron-capture-cross-section atoms for capturing the neutrons and emitting electromagnetic radiation, at least one dimension of the scintillator exceeding the mean free path in the scintillator of a photon of a specified wavelength range; and
b. detecting photons at the specified wavelength range with a photodetector characterized by a position with respect to the scintillator.

9. A method according to claim 8, further comprising:
c. inferring a direction of a detected neutron with the position of the photodetector.

10. A method according to claim 8, further including the step of moderating incident fast neutrons for capture by the containing high neutron-capture-cross-section atoms.

11. A detector for detecting high-energy photons with enhanced efficiency, the detector comprising:
a. a first scintillator screen in a path of photons;
b. a heavy element backing in a path of photons that have traversed the first scintillator screen for generating Auger electrons and concomitant secondary photons; and
c. a photodetector for detecting visible photons arising in the first scintillator screen.

12. A detector according to claim 11, further comprising a second scintillator screen traversed in the path of photons to the first scintillator screen, for increasing an x-ray detection efficiency.

13. A detector according to claim 11, further comprising a second scintillator screen traversed in the path of photons to the first scintillator screen, the second screen comprising a neutron-detecting scintillator.

14. A detector according to claim 13, wherein the neutron-detecting scintillator in gadox.

15. A method for detecting concealed fissile material comprising:
a. providing:
i. a first scintillator screen for absorbing massive fission products and generating visible light;
ii. a second scintillator screen in a path of photons that have traversed the first scintillator screen;
iii. a heavy element backing in a path of photons that have traversed the second scintillator screen for generating Auger electrons and concomitant secondary photons; and
b. detecting visible photons arising in the first and second scintillators.
